(19) United States
(12) Patent Application Publication
(10) Pub. No.: US 2014/0269336 A1
(43) Pub. Date: Sep. 18, 2014

(54) METHOD AND APPARATUS FOR MONITORING PHYSICAL DOWNLINK CONTROL CHANNEL IN A SYSTEM HAVING CELLS

(71) Applicant: LG ELECTRONICS INC., Seoul (KR)

(72) Inventors: Sun Young LEE, Anyang-si (KR); Sung Jun PARK, Anyang-si (KR); Seung June YI, Anyang-si (KR)

(73) Assignee: LG ELECTRONICS INC., Seoul (KR)

(21) Appl. No.: 13/828,727

(22) Filed: Mar. 14, 2013

(51) Int. Cl. H04W 24/08

(52) U.S. Cl. CPC H04W 24/08
USPC 370/241

(57) ABSTRACT

A method and apparatus for performing communication associated with carrier aggregation are provided. The present description provides a method comprising: configuring, by a user equipment (UE), a primary cell (P-cell) and at least one secondary cell (S-cell); and monitoring, by the UE, at least one physical downlink control channel (PDCCH) transmitted on the at least one S-cell in a subframe if the P-cell is not configured as an uplink subframe in the subframe. In the method, the UE may operate in a half-duplex TDD mode. Further, first TDD configuration can be applied to the P-cell and second TDD configuration different from the first TDD configuration can be applied to the S-cell.

### BACKGROUND OF THE INVENTION

1. Field of the Invention

The technical features of this document relate to a communication system employing carrier aggregation (CA) scheme, and more particularly, to a method and apparatus for performing communication by monitoring a physical downlink control channel transmitted on a cell associated with the carrier aggregation scheme.

2. Related Art

The Third Generation Partnership Project (3GPP) Long Term Evolution (LTE) which is a set of enhancements to the Universal Mobile Telecommunications System (UMTS) is introduced as 3GPP Release 8. The 3GPP LTE uses orthogonal frequency division multiple access (OFDMA) for a downlink, and uses single carrier frequency division multiple access (SC-FDMA) for an uplink, and adopts multiple input multiple output (MIMO) with up to four antennas. In recent years, there is an ongoing discussion on 3GPP LTE-Advanced (LTE-A), which is a major enhancement to the 3GPP LTE.

In order to increase the performance of 3GPP LTE system, a number of technical features are newly introduced in LTE-A system. Examples of the new technical features include the concept of carrier aggregation (CA). In detail, to meet LTE-A requirements, support of wider transmission bandwidths is required than the 20 MHz bandwidth specified in 3GPP Release 8/9, and the carrier aggregation (CA) scheme has been introduced as a preferred solution. Carrier aggregation (CA) allows expansion of effective bandwidth delivered to a user equipment (UE) through concurrent utilization of radio resources across multiple carriers. Multiple component carriers (CCs) are aggregated to form a larger overall transmission bandwidth.

### SUMMARY OF THE INVENTION

A method and apparatus receiving data associated with the concept of carrier aggregation are introduced in the present description. The method can performed by an receiver which can be implemented as a user equipment communication with a number of cell associated with the carrier aggregation.

The present description provides a method comprising: configuring, by a user equipment (UE), a primary cell (P-cell) and at least one secondary cell (S-cell); and monitoring, by the UE, at least one physical downlink control channel (PDCCH) transmitted on the at least one S-cell in a subframe if the P-cell is not configured as an uplink subframe in the subframe.

In the method, the UE may operate in a half-duplex TDD mode. Further, a first TDD configuration can be applied to the P-cell and a second TDD configuration different from the first TDD configuration can be applied to the S-cell.

In the method, the UE monitors the at least one PDCCH during active time related to discontinuous reception (DRX) operation.

In the method, the P-cell not configured as an uplink subframe means a P-cell configured as a downlink subframe or a subframe including a downlink pilot timeslot (DwPTS).

In the method, the UE does not monitor the at least one PDCCH transmitted on the at least one S-cell in the subframe if the P-cell is configured as the uplink subframe in the subframe.

In one aspect, a user equipment (UE) for performing communication is further provided. The UE comprises a radio frequency (RF) unit configured to transmit and receive a signal; and a processor coupled to the RF unit and configured to: configure a primary cell (P-cell) and at least one secondary cell (S-cell); and monitor at least one physical downlink control channel (PDCCH)transmitted on the at least one S-cell in a subframe if the P-cell is not configured as an uplink subframe in the subframe.

### BRIEF DESCRIPTION OF THE DRAWINGS

FIG. 1 shows a wireless communication system to which the technical features of this description can be applicable.

FIG. 2 shows the structure of a radio frame.

FIG. 3 shows an example of a resource grid for one downlink slot.

FIG. 4 shows an example of the structure of a downlink subframe in 3GPP LTE.

FIG. 5 shows an exemplary structure of an uplink subframe.

FIG. 6 shows an example of a comparison between the existing single carrier system and a multi-carrier system.

FIG. 7 illustrates the structure of a subframe for cross-carrier scheduling in a multi-carrier system.

FIG. 8 shows the structure of the special subframe in TDD.

FIG. 9 shows a case where a half-duplex TDD UE communicates with a number of cells to which different TDD configurations are applied.

FIG. 10 shows a flow chart illustrating the proposed scheme.

FIG. 11 is a block diagram showing a wireless apparatus to implement technical features of this description.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The OFDMA can be implemented with a radio technology such as institute of electrical and electronics engineers (IEEE) 802.11 (Wi-Fi), IEEE 802.16 (WiMAX), IEEE 802.20, evolved UTRA (E-UTRA), etc. The UTRA is a part of a universal mobile telecommunication system (UMTS). The 3^{rd} generation partnership project (3GPP) long term evolution (LTE) is a part of an evolved UMTS (E-UMTS) using the E-UTRA. The 3GPP LTE uses the OFDMA in the downlink and uses the SC-FDMA in the uplink.

For clarity of explanation, the following description will focus on the 3GPP LTE and its evolution. However, the technical features of this description are not limited thereto.

FIG. 1 shows a wireless communication system to which the technical features of this description can be applicable.

Referring to FIG. 1, the wireless communication system 10 includes one or more Base Stations (BSs) 11. The BSs 11 provide communication services to specific geographical areas 15 commonly called cells. Each of the cells may be divided into a plurality of areas, and each of the areas is called a sector. One BS may include one or more cells. In general, the BS 11 refers to a fixed station that communicates with UEs 13, and it may also be called another terminology, such as an evolved NodeB (eNB), a Base Transceiver System (BTS), an access point, or an Access Network (AN).

The User Equipment (UE) 12 may be fixed or mobile and may also be called another terminology, such as a Mobile Station (MS), a User Terminal (UT), a Subscriber Station (SS), a wireless device, a Personal Digital Assistant (PDA), a wireless modem, a handheld device, or an Access Terminal (AT).

Hereinafter, downlink (DL) refers to communication from the BS 11 to the UE 12, and uplink (UL) refers to communication from the UE 12 to the BS 11.

The wireless communication system 10 may be a system which supports bidirectional communication. Bidirectional communication can be performed using Time Division Duplex (TDD) mode, Frequency Division Duplex (FDD) mode or the like. TDD mode uses different time resources in UL transmission and DL transmission. FDD mode uses different frequency resources in UL transmission and DL transmission. The BS 11 and the UE 12 communicate with each other using radio resources, which can be referred to as radio frames.

FIG. 2 shows the structure of a radio frame.

Based on one example depicted in FIG. 2, the radio frame may include 10 subframes, and one subframe may include two slots. The length of one subframe may be 1 ms, and the length of one slot may be 0.5 ms. The time during which one subframe is transmitted can be called a Transmission Time Interval (TTI). The TTI may be a minimum scheduling unit.

One slot may include a plurality of Orthogonal Frequency Division Multiplexing (OFDM) symbols in the time domain. For downlink, the OFDM symbol is used to represent one symbol period because 3GPP LTE (and its evolution) uses OFDMA in downlink. In the meantime, for uplink, Single Carrier-Frequency Division Multiple Access (SC-FDMA) scheme is used, and thus a SC-FDMA symbol is used to represent one symbol period for uplink.

One slot is illustrated as including 7 OFDM symbols, but the number of OFDM symbols included in one slot may be changed depending on the length of a Cyclic Prefix (CP). In accordance with 3GPP TS 36.211 V8.5.0 (2008-12), 1 subframe includes 7 OFDM symbols in a normal CP, and 1 subframe includes 6 OFDM symbols in an extended CP. The structure of the radio frame is only an example, and the number of subframes included in the radio frame and the number of slots included in the subframe may be changed in various ways.

FIG. 3 shows an example of a resource grid for one downlink slot.

Referring to FIG. 3, the downlink slot includes a plurality of OFDM symbols in the time domain and includes N_{RB} Resource Blocks (RBs) in the frequency domain. The resource block is a resource allocation unit, and it includes one slot in the time domain and includes a plurality of contiguous subcarriers in the frequency domain.

The number of resource blocks N_{RB} included in a downlink slot depends on a downlink transmission bandwidth configured in a cell. For example, in an LTE system, the number of resource blocks NRB may be any one of 60 to 110. An uplink slot may have the same structure as the downlink slot.

Each of elements on the resource grid is called a Resource Element (RE). The resource elements on the resource grid may be identified by an index pair (k, 1) within a slot. Here, k (k=0, . . . , N_{RB}×12−1) indicates a subcarrier index in the frequency domain, and l (l=0, . . . , 6) indicates an OFDM symbol index in the time domain.

In FIG. 3, one resource block is illustrated as including 7×12 resource elements, including 7 OFDM symbols in the time domain and 12 subcarriers in the frequency domain. However, the number of OFDM symbols and the number of subcarriers within a resource block are not limited thereto. The number of OFDM symbols and the number of subcarriers may be changed in various ways depending on the length of a CP, frequency spacing, etc. For example, the number of OFDM symbols is 7 in case of a normal CP, and the number of OFDM symbols is 6 in case of an extended CP. One of 128, 256, 512, 1024, 1536, and 2048 may be selected and used as the number of subcarriers in one OFDM symbol.

FIG. 4 shows an example of the structure of a downlink subframe in 3GPP LTE. As described above, the subframe may include two consecutive slots. A maximum of three OFDM symbols, which are initially transmitted in a first slot within the downlink subframe, become a control region to which a physical downlink control channel (PDCCH) is allocated, and the remaining OFDM symbols become a data region to which physical downlink shared channels (PDSCHs) are allocated. Control channels, such as a physical control format indicator channel (PCFICH) and a physical hybrid ARQ indicator channel (PHICH), in addition to the PDCCH can be allocated to the control region. UE can read data information transmitted through the PDSCHs by decoding control information transmitted through the PDCCH. Here, the control region is illustrated as including the 3 OFDM symbols, but this is only illustrative. The PDCCH carries a downlink grant that informs the allocation of the resources of downlink transmission on the PDSCH. More particularly, the PDCCH can carry the allocation of the resources of the transport format of a downlink shared channel (DL-SCH), paging information on a paging channel (PCH), system information on a DL-SCH, the allocation of the resources of a higher layer control message, such as a random access response transmitted on a PDSCH, a transmission power control command, and the activation of a voice over IP (VoIP). Furthermore, the PDCCH carries an uplink grant that informs UE of the allocation of resources of uplink transmission. The number of OFDM symbols included in the control region within the subframe can be known by a PCFICH. The PHICH carries Hybrid Automatic Repeat reQuest (HARQ) acknowledgment (ACK)/negative-acknowledgement (NACK) signals in response to uplink transmission.

FIG. 5 shows an exemplary structure of an uplink subframe.

Referring to FIG. 5, the uplink subframe can be divided into a control region and a data region in the frequency domain. A physical uplink control channel (PUCCH) on which uplink control information is transmitted is allocated to the control region. A physical uplink shared channel (PUSCH) on which data (control information may also be transmitted according to circumstances) is transmitted is allocated to the data region. UE may transmit a PUCCH and a PUSCH at the same time or may transmit only one of a PUCCH and a PUSCH depending on a configuration.

A PUCCH for an UE is allocated in the form of a resource block pair (RB pair) in the subframe. Resource blocks that belong to the resource block pair occupy different subcarriers in a first slot and a second slot. A frequency that is occupied by the resource blocks belonging to the resource block pair to which a PUCCH is allocated is changed on the basis of a slot boundary. This is said that the RB pair allocated to the PUCCH has been subjected to frequency-hopped at the slot boundary. UE can obtain a frequency diversity gain by transmitting uplink control information through different subcarriers according to the time.

A Hybrid Automatic Repeat reQuest (HARQ) acknowledgement (ACK)/non-acknowledgement (NACK), and Channel Status Information (CSI) (e.g., a Channel Quality Indicator (CQI), a Precoding Matrix Index (PMI), a Precoding Type Indicator (PTI), and a Rank Indication (RI)) indicating a downlink channel state can be transmitted on the PUCCH.

The PUSCH is mapped to an UL-Uplink Shared Channel (SCH), that is, a transport channel. Uplink data transmitted on the PUSCH may be a transport block, that is, a data block for the UL-SCH transmitted during a TTI. The transport block may include user data. Or, the uplink data may be multiplexed data. The multiplexed data may be the multiplexing of the transport block for the UL-SCH and channel status information.

Hereinafter the concept of carrier aggregation of a multi-carrier system is further explained.

FIG. 6 shows an example of a comparison between the existing single carrier system and a multi-carrier system.

Referring to FIG. 6, in the single carrier system, only one carrier is supported for an UE in uplink and downlink. The bandwidth of a carrier may be various, but the number of carriers allocated to an UE is one. In contrast, in the multi-carrier system, a plurality of component carriers (e.g., Downlink Component Carriers A to C and Uplink Component Carriers A to C) can be allocated to an MS. For example, in order to allocate a bandwidth of 60 MHz to an MS, 3 CCs each having 20 MHz may be allocated to the MS.

The multi-carrier system may be divided into a contiguous carrier aggregation (CA) system in which aggregated carriers are contiguous to each other and a non-contiguous CA system in which aggregated carriers are spaced apart from each other. When a multi-carrier system is simply recited hereinafter, it is to be understood that the multi-carrier system includes both a case where component carriers (CCs) are contiguous to each other and a case where CCs are not contiguous to each other.

A CC, that is, a target when aggregating one or more CCs may use bandwidths used in the existing system for the purpose of backward compatibility with the existing system. For example, a 3GPP LTE system supports bandwidths of 1.4 MHz, 3 MHz, 5 MHz, 10 MHz, 15 MHz, and 20 MHz. A 3GPP LTE-A system can configure a broadband of 20 MHz or higher using only the bandwidths of the 3GPP LTE system. Or, a 3GPP LTE-A system may configure a broadband by defining new bandwidths without using the bandwidths of the existing system.

The system band of a wireless communication system is classified into a plurality of carrier frequencies. Here, the carrier frequency means the center frequency of a cell. Hereinafter, a cell may mean downlink frequency resources and uplink frequency resources. Or, a cell may mean a combination of downlink frequency resources and optional uplink frequency resources. Furthermore, in general, if a CA is not taken into consideration, one cell may always include uplink and downlink frequency resources that form a pair. In order for packet data to be transmitted and received through a specific cell, an UE first has to complete a configuration for the specific cell. The configuration means a state in which the reception of system information necessary to transmit and receive data to and from the specific cell has been completed. For example, the configuration may include an overall process of receiving common physical layer parameters necessary for the transmission/reception of data, MAC layer parameters, or parameters necessary for a specific operation in the RRC layer. A configuration-completed cell is in a state in which the cell can immediately transmit and receive packet data only it has only to receive information about which the packet data can be transmitted.

A cell of a configuration-completed state may be in an activation or deactivation state. Here, the activation can refer to a state in which data is being transmitted or received or a state in which data is ready to be transmitted or received. An UE can monitor and receive the control channel (PDCCH) and data channel (PDSCH) of an activated cell in order to check resources (they may be the frequency, the time, etc.) allocated thereto.

Deactivation can refer to a state in which traffic data cannot be transmitted or received, but measurement or the transmission/reception of minimum information are possible. An UE can receive necessary System Information (SI) in order to receive packets from a deactivated cell. In contrast, the UE does not monitor or receive the control channel (PDCCH) and data channel (PDSCH) of a deactivated cell in order to check resources (they may be a frequency, time, etc.) allocated thereto.

A cell may be classified into a primary cell, a secondary cell, and a serving cell.

The primary cell (P-cell) may mean a cell that operates in a primary frequency, a cell in which an UE performs an initial connection establishment procedure or a connection re-establishment procedure with a BS, or a cell that is indicated as a primary cell in a handover process. The secondary cell (S-cell) may mean a cell that operates in a secondary frequency. The secondary cell is configured once RRC establishment is set up and used to provide additional radio resources.

The serving cell is formed of a primary cell in the case of an UE in which a Carrier Aggregation (CA) has not been configured or to which a CA cannot be provided. If a CA has been configured for an MS, the term ‘serving cell’ is used to indicate a primary cell and one of all secondary cells or a set of a plurality of secondary cells. That is, a primary cell means one serving cell which provides security inputs and NAS mobility information in an RRC establishment or re-establishment state. At least one cell may be configured to form a set of serving cells along with a primary cell depending on the capabilities of UE. The at least one cell is called a secondary cell. Accordingly, a set of serving cells configured for one UE may be formed of only one primary cell or may be formed of one primary cell and at least one secondary cell.

A Primary Component Carrier (PCC) means a Component Carrier (CC) corresponding to a primary cell. A PCC is a CC through which an UE forms connection or RRC connection with a BS at the early stage from among some CCs. A PCC is a special CC that is responsible for connection or RRC connection for signaling regarding a plurality of CCs and that manages UE context, that is, connection information related to an MS. Furthermore, a PCC is always in the activation state when it is in RRC connected mode after forming connection or RRC connection with an MS.

A Secondary Component Carrier (SCC) means a CC corresponding to a secondary cell. That is, an SCC is a CC allocated to an UE in addition to a PCC and is a carrier extended for additional resource allocation, etc. by an UE in addition to a PCC. An SCC may be divided into the activation or deactivation state.

A downlink CC (DL CC) corresponding to a primary cell is called a downlink Primary Component Carrier (DL PCC), and an uplink CC (UL CC) corresponding to a primary cell is called an uplink Primary Component Carrier (UL PCC). Furthermore, in downlink, a CC corresponding to a secondary cell is called a downlink Secondary Component Carrier (DL SCC). In uplink, a CC corresponding to a secondary cell is called an uplink Secondary Component Carrier (UL SCC).

A primary cell and a secondary cell have at least one of the following characteristics. First, a primary cell is used to transmit a PUCCH. Second, a primary cell is always activated, whereas a secondary cell is a carrier that is activated or deactivated according to specific conditions. Third, when a primary cell experiences a Radio Link Failure (hereinafter referred to as an RLF), RRC re-establishment is triggered, or a secondary cell experiences an RLF, RRC re-establishment is not triggered. Fourth, a primary cell may be changed by a change of a security key or by a handover procedure that is accompanied by a random access channel (RACH) procedure. Fifth, Non-Access Stratum (NAS) information is received through a primary cell. Sixth, a primary cell is always formed of a pair of a DL PCC and an UL PCC. Seventh, a different CC may be configured as a primary cell in each MS. Eighth, procedures, such as the reconfiguration, addition, and removal of a primary cell, can be performed by the RRC layer. In adding a new secondary cell, RRC signaling may be used to transmit system information about a dedicated secondary cell.

A DL CC may form one serving cell, or a DL CC and an UL CC may form one serving cell through connection establishment. However, a serving cell may not be formed of only one UL CC. In the meantime, the activation/deactivation of a CC has the same concept as the activation/deactivation of a serving cell. For example, assuming that a serving cell1 is formed of a DL CC1, the activation of the serving cell1 means the activation of the DL CC1. Assuming that a serving cell2 is configured through connection establishment of a DL CC2 and an UL CC2, the activation of the serving cell2 means the activation of the DL CC2 and the UL CC2. In this sense, each CC may correspond to a cell.

The number of CCs that are aggregated between downlink and uplink may be differently set. A case where the number of aggregated DL CCs is the same as the number of aggregated UL CCs is called a symmetric aggregation, and a case where the number of aggregated DL CCs is different from the number of aggregated UL CCs is called an asymmetric aggregation. Furthermore, the CCs may have different sizes (i.e., bandwidths). For example, assuming that 5 CCs are used to form a 70 MHz band, the 70 MHz band may be configured like 5 MHz CC (carrier #0)+20 MHz CC (carrier #1)+20 MHz CC (carrier #2)+20 MHz CC (carrier #3)+5 MHz CC (carrier #4).

As described above, unlike a single carrier system, a multi-carrier system can support a plurality of Component Carriers (CCs). That is, one UE can receive a plurality of PDSCHs through a plurality of DL CCs.

A multi-carrier system can support cross-carrier scheduling. Cross-carrier scheduling is a scheduling method capable of performing the resource allocation of a PDSCH transmitted through other CCs and/or the resource allocation of a PUSCH transmitted through CCs other than CCs that is basically linked to a specific CC, through a PDCCH transmitted through the specific CC. That is, a PDCCH and a PDSCH may be transmitted through different DL CCs, and a PUSCH can be transmitted through UL CCs other than an UL CC that is linked to a DL CC on which a PDCCH including an UL grant has been transmitted. As described above, a system which supports cross-carrier scheduling requires a carrier indicator for indicating information related to the cross-carrier scheduling. A field including this carrier indicator is hereinafter called a Carrier Indicator Field (CIF).

A multi-carrier system which supports cross-carrier scheduling may include a CIF in a conventional Downlink Control Information (DCI) format. In a system which supports cross-carrier scheduling, for example, LTE-A system, 1 to 3 bits can be extended because a CIF is added to the existing DCI format (i.e., a DCI format used in LTE). The PDCCH structure may reuse the existing coding method and resource allocation method (i.e., resource mapping based on a CCE).

FIG. 7 illustrates the structure of a subframe for cross-carrier scheduling in a multi-carrier system.

Referring to FIG. 7, a BS may configure a PDCCH monitoring DL CC set. The PDCCH monitoring DL CC set includes some of all aggregated DL CCs. When cross-carrier scheduling is configured, an UE performs PDCCH monitoring/decoding on only DL CCs that are included in a PDCCH monitoring DL CC set. In other words, a BS transmits a PDCCH for a PDSCH/PUSCH to be scheduled through DL CCs that are included in a PDCCH monitoring DL CC set. A PDCCH monitoring DL CC set may be configured in a UE-specific, UE group-specific, or cell-specific way.

FIG. 7 shows an example in which 3 DL CCs (i.e., DL CC A, DL CC B, and DL CC C) are aggregated and the DL CC A has been set as a PDCCH monitoring DL CC. An UE can receive DL grants for the PDSCHs of the DL CC A, the DL CC B, and the DL CC C through the PDCCH of the DL CC A. DCI that is transmitted through the PDCCH of the DL CC A includes a CIF, and thus it can indicate that the DCI is DCI for what DL CC.

Hereinafter, technical features of TDD applicable to the present description are explained in detail.

As explained above, 3GPP LTE and its evolution support the TDD scheme. For TDD system, unpaired spectrum can be used, whereas FDD can rely on paired radio spectrum. In detail, while TDD can have the same basic structure of RBs and REs as FDD, only a subset of the subframes are available for downlink transmission; and the remaining subframes are used for uplink transmission or for special subframes which allow for switching between downlink and uplink transmission. Control information indicating specific allocation of uplink, downlink, and special subframes can be referred to as TDD configurations or uplink/downlink TDD configurations. Such TDD configurations can be predefined and indicated by a numeral. Examples of the TDD configurations applicable to 3GPP LTE system can be represented by the following Table 1. In Table 1, the special subframe is denoted by ‘S’ whereas the downlink subframe and uplink subframe are denoted by ‘D’ and ‘U’, respectively.

TABLE 1

| | Downlink- | | | | | | | | | | |
|---|---|---|---|---|---|---|---|---|---|---|---|
| | to-Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

It should be noted that a specific TDD configuration in Table 1 is introduced for exemplary purposes only, and thus the present description is not limited thereto. Meanwhile, TDD configurations can be configured in a basis of cells. For instance, TDD configurations can be predetermined in a cell-specific manner.

FIG. 8 shows the structure of the special subframe in TDD.

The special subframe consists of Downlink Pilot TimeSlot (DwPTS), Guard Period (GP), and Uplink Pilot TimeSlot (UpPTS). As shown in FIG. 8, the DwPTS is directed to downlink communication while the UpPTS is directed to uplink communication.

With respect to the carrier aggregation, the concept of ‘half-duplex TDD UE’ can be utilized. In detail, a certain UE being able to communicate with the P-cell and the S-cell based on the TDD scheme may not have the capability of transmitting and receiving data in a subframe simultaneously. Such UE can be referred to as the ‘half-duplex TDD UE’. Technical features of the present description can be applicable to the ‘half-duplex TDD UE’.

In the meantime, the above-explained TDD configuration can be applicable a number of cells. In case where different TDD configurations are applied to a P-cell and S-cell and the UE operates in the half-duplex TDD mode, the technical problem may occur in which transmission direction of UE must be clearly defined.

FIG. 9 shows a case where a half-duplex TDD UE communicates with a number of cells to which different TDD configurations are applied.

If different TDD configurations are applied (e.g., 1^{st} TDD configuration to S-cell and 2^{nd} TDD configuration to P-cell), a 4^{th} subframe 930 transmitted on P-cell can be set to an uplink subframe denoted by ‘U’ and another 4^{th} subframe 920 transmitted on S-cell can be set to a downlink subframe denoted by ‘D’. Although TDD UEs with full-duplex capability would not have problem associated with the transmission direction, the half-duplex TDD UE 910 is required to determine its transmission direction since it cannot transmit and receive data in a subframe simultaneously.

In the current standard related to a MAC layer, for the full-duplex TDD UE, the PDCCH-subframe is defined per UE by a union approach based on the scheduling serving cells. Accordingly, a PDCCH-subframe is understood in view of union of PDCCHs transmitted on plurality of cells. For instance, a subframe transmitted on the 4^{th} subframe in FIG. 9 can be understood as a PDCCH-subframe based on the union approach, regardless of which cell the PDCCH is transmitted based on. In the standard, the PDCCH-subframe is used for counting timers related to discontinuous reception (DRX) and UE's PDCCH monitoring behavior. The UE shall monitor the PDCCH in the PDCCH-subframe in Active Time during which a PDCCH is monitored, if the PDCCH-subframe is a downlink (DL) or special subframe of the serving cell.

However, since the half-duplex mode UE cannot transmit and receive simultaneously, with respect to the transmission direction of UEs, further study has been required to properly handle the UE's behavior.

In the present description, with respect to the transmission direction, the following two approaches are discussed:
Alternative 1: the transmission direction of all subframes is set to follow P-Cell SIB1 configuration;
Alternative 2: the transmission direction is determined by a base station (eNB). In Alternative 2, the scheduling direction can be dynamically determined by the base station, and once the scheduling direction is determined, the determined scheduling direction becomes prioritized for all serving cells.

Hereinafter, detailed features related to Alternative 1 are explained.

Based on Alternative 1, the scheduling direction for the half-duplex mode UE is set based on the P-Cell. Namely, if a downlink subframe is allocated on the P-cell, the downlink is prioritized over the uplink for all serving cells and the scheduling direction is set to downward or downlink. In other words, regardless of whether a certain subframe is a PDCCH-subframe based on the union approach, the scheduling direction for the half-duplex mode UE is determined exclusively based on the transmission direction of the P-cell.

Accordingly, Alternative 1 of the present description allows a subframe, which is a PDCCH-subframe but cannot be used for receiving data from the base station. For instance, if Alternative 1 of the present description is applied to an example of FIG. 9, the transmission direction, which is determined exclusively based on the P-cell, is set to ‘uplink’ or ‘upward’, regardless of the existence of a PDCCH-subframe in the 4^{th} subframe. Namely, the 4^{th} subframe 920 transmitted on S-cell can be a subframe which is PDCCH-subframe but cannot be used for receiving data from the base station.

In the meantime, it can be understood that Alternative 1 of the present description provides a group of PDCCHs required to be monitored by half-duplex TDD UEs and another group of PDCCHs not required to be monitored by the half-duplex TDD UEs. Namely, if there is a subframe which is a PDCCH-subframe but cannot be used for receiving data from the base station, and if no downlink scheduling is allocated for such subframe, it is preferred that the half-duplex TDD UE should not monitor the subframe. Consequently, it can be said that a PDCCH monitoring is not required for half-duplex TDD UEs, if the P-cell is configured as an uplink subframe and the S-cell is configured as a downlink subframe or special subframe.

PDCCHs required to be monitored by half-duplex TDD UEs can be determined by the same rationale. That is, if the P-cell is not configured as an uplink subframe and if the S-cell is configured as a downlink subframe or special subframe, corresponding PDCCH should be monitored by half-duplex TDD UEs. In other words, for each subframe, if the subframe is not required for uplink transmission (i.e., P-cell is not configured for an uplink subframe) for half-duplex TDD UE operation, the UE monitors PDCCH in the PDCCH-subframe (i.e., PDCCH transmitted on the S-cell which is configured as a downlink subframe or special subframe).

Therefore, the present description proposes that, for each subframe, if the P-cell is not configured as an uplink subframe in the subframe, the UE monitors at least one PDCCH transmitted on at least one S-cell in the subframe.

The UE behavior related to the above-explained PDCCH monitoring may affect the operation of Discontinuous Reception (DRX). Therefore, a group of PDCCHs required to be monitored and another group of PDCCHs not required to be monitored by half-duplex TDD UEs should be understood in the context of DRX operations.

Based on the conventional art, DRX functionality can be configured for an RRC_CONNECTED UE so that it does not always need to monitor the downlink channels, and a DRX cycle consists of an ‘On Duration’ during which the UE should monitor the PDCCH and a ‘DRX period’ during which a UE can skip reception of downlink channels for battery saving purposes. The ‘On Duration’ can be referred to as ‘Active Time’. Therefore, the Active Time indicates time related to DRX operation during which the UE monitors the PDCCH in PDCCH-subframes.

For DRX operation, a number of timers are configured to correctly specify the length of the Active Time, and the Active Time can be understood in the context of the timers. For instance, it can be said that the Active Time includes the time while ‘onDurationTimer’ or ‘drx-InactivityTimer’ or ‘drx-RetransmissionTimer’ or ‘mac-ContentionResolutionTimer’ are running. The timers related to the DRX operation are fully described in 3GPP TS 36.321, MAC protocol specification, V11.0.0, which is incorporated by reference in its entirety herein.

If the DRX functionality is further adopted in the half-duplex TDD UE, the UE monitors a PDCCH transmitted on the S-cell in a subframe during the Active Time if the P-cell is not configured as an uplink subframe in the subframe.

FIG. 10 shows a flow chart illustrating the proposed scheme. The proposed method of FIG. 10 is applicable to a receiver, which monitor a PDCCH transmitted from a network. The receiver can be implemented as a user equipment (UE).

Referring to FIG. 10, the UE configures a primary cell (P-cell) and at least one secondary cell (S-cell) (Step S1010). Before configuring the P-cell and the S-cell, the UE may receive control or system information related to the P-cell and the S-cell.

As shown in Step S1020 in FIG. 10, the UE monitors at least one PDCCH transmitted on the S-cell if the P-cell is not configured as an uplink in the subframe. As described above, the UE of FIG. 10 can be a TDD UE. Further, the UE of FIG. 10 can be a half-duplex TDD UE. When operating in TDD mode, different configurations can be applicable to the P-cell and the S-cell. For instance, a first TDD configuration can be applied to the P-cell and a second TDD configuration different from the first TDD configuration can be applied to the S-cell. Namely, as described in FIG. 9, a certain subframe of the P-cell can be ‘U’ while the subframe transmitted on the S-cell can be set to ‘D’, when different TDD configurations are applied. In this case, the transmission direction is determined based on that of the P-cell, and the UE operates based on the procedure depicted in FIG. 10, thereby not monitoring the PDCCH.

As described above, the subframe can be one of a downlink subframe, uplink subframe, and special subframe consisting of DwPTS, GP, and UpPTS. Therefore, the P-cell not configured as an uplink subframe means a P-cell configured as a downlink subframe or a subframe including a downlink pilot timeslot (DwPTS).

When the DRX functionality is employed in the UE, the UE monitors PDCCH during the Active Time associated with the DRX operation. As explained above, the Active Time is an on duration during which the UE monitors the PDCCH and is repeated with an unmonitored duration in an alternate manner. Accordingly, the present description proposes that the UE monitors the PDCCH transmitted on the S-cell during the active time in a subframe, if the P-cell is not configured as an uplink subframe in the subframe.

Further, as described above, when the P-cell is configured as an uplink subframe and the S-cell is configured as the downlink subframe or the special subframe, the UE can skip monitoring of the PDCCH. Namely, the UE can be configured not to monitor the PDCCH transmitted on the S-cell in a subframe if the P-cell is configured as an uplink subframe in the subframe.

FIG. 11 is a block diagram showing a wireless apparatus to implement technical features of this description. This may be a part of a UE, which operates a in half-duplex TDD mode. The above-explained method can be applicable to the wireless apparatus 1000 of FIG. 11. The wireless apparatus 1000 may include a processor 1010, a memory 1020 and a radio frequency (RF) unit 1030.

The processor 1010 may be configured to implement proposed functions, procedures and/or methods described in this description. Layers of the radio interface protocol may be implemented in the processor 1010. The processor 1010 may handle a procedure explained above. The memory 1020 is operatively coupled with the processor 1010, and the RF unit 1030 is operatively coupled with the processor 1010.

The processor 1010 may include application-specific integrated circuit (ASIC), other chipset, logic circuit and/or data processing device. The memory 1020 may include read-only memory (ROM), random access memory (RAM), flash memory, memory card, storage medium and/or other storage device. The RF unit 1030 may include baseband circuitry to process radio frequency signals. When the embodiments are implemented in software, the techniques described herein can be implemented with modules (e.g., procedures, functions, and so on) that perform the functions described herein. The modules can be stored in memory 1020 and executed by processor 1010. The memory 1020 can be implemented within the processor 1010 or external to the processor 1010 in which case those can be communicatively coupled to the processor 1010 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the scope of the appended claims.

What is claimed is:

1. A method of performing communication in a mobile communication system, the method performed comprising:
configuring, by a user equipment (UE), a primary cell (P-cell) and at least one secondary cell (S-cell); and
monitoring, by the UE, at least one physical downlink control channel (PDCCH) transmitted on the at least one S-cell in a subframe if the P-cell is not configured as an uplink subframe in the subframe.

2. The method of claim 1, wherein the UE operates in a time division duplex (TDD) mode.

3. The method of claim 1, wherein the UE operates in a half-duplex TDD mode.

4. The method of claim 1, wherein the UE monitors the at least one PDCCH during active time related to discontinuous reception (DRX) operation.

5. The method of claim 1, wherein the P-cell not configured as an uplink subframe means a P-cell configured as a downlink subframe or a subframe including a downlink pilot timeslot (DwPTS).

6. The method of claim 1, wherein the UE does not monitor the at least one PDCCH transmitted on the at least one S-cell in the subframe if the P-cell is configured as the uplink subframe in the subframe.
